(19) United States
(12) Patent Application Publication
(10) Pub. No.: US 2001/0048440 A1
(43) Pub. Date: Dec. 6, 2001

(54) Method for examining animated objects with ultrasound

(75) Inventor: Franz Wiesauer, Zipf (AT)

Correspondence Address: Kurt Kelman, COLLARD & ROE, P.C., 1077 Northern Boulevard, Roslyn, NY, 11576, US

(73) Assignee: KRETZTECHNIK AG

(21) Appl. No.: 09/874,146

(22) Filed: Jun. 5, 2001

(30) Foreign Application Priority Data
Jun. 6, 2000 (EP) 00890184.5

(51) Int. Cl. G06T 13/00

(52) U.S. Cl. 345/473

(57) ABSTRACT

In a method for representing movements when examining animated objects with ultrasound, the object is scanned with an ultrasound split-field unit (1) adjusted to one cutting plane only. The signals obtained from successive split image scannings are converted in a memory (3) into a virtual three-dimensional data block, in which the third dimension results from a preset or selectable time interval between successively recorded split images. From the stored data block data are called up by way of one or more console inquiry stations (4, 5) and according to adjustable criteria, namely interfaces or cutting axes by way of this data block or according to signal criteria, and images are displayed on at least one display unit (7) in the form of split images (8), motion curves (11, 12), and height-adjusted or depth-adjusted or axonometrically displayed groups of curves (13) giving a spatial impression, or as a three-dimensional impression.

### FIELD OF THE INVENTION

The present invention relates to a method for representing movements when examining animated objects with ultrasound, wherein the object is scanned with an ultrasound split-field unit and the split images are stored in a memory unit.

### DESCRIPTION OF THE PRIOR ART

Various methods of ultrasound examination and of showing the signals obtained from the examination on display units, monitors in particular are well known per se. The so-called M image technique is the simplest method for depicting movement. Here, the object to be examined, such as A images of still objects are scanned with a sound beam and the echoes received from the animated object are depicted as time-dependent curves. In the case of heart examinations this technique is also known as “ultrasound cardiogram UCG)”. The respective movement is indicated in a curve, whereby distinction can be made between images of the heart surface and images of heart valve movement. In addition to this an acoustic display of, for example, the sound of the heart valves can be obtained by processing the echo signals for instance by way of low-pass filter or operation amplifier.

With a normal simple split-field image the movement of the object can be observed directly on the screen at a correspondingly high frequency of the scan cycles. It is also known to store a series of time-lapsed split images. The automatic reproduction of this image series is also designated as film mode. In a longer scan procedure it is always the last recorded split images which are kept, so that on completion of the scanning procedure these last recorded images can be called up for viewing in succession or in any other way both individually and successively. Each known individual image known as a “B image” represents only one recorded moment, such that—just as for observing an animated split image—the precision of diagnosis depends on skill and the talent for observation on the part of the examiner.

Finally, it is known to scan entire volume areas of the object being examined with the aid of a so-called 3D ultrasound probe, correctly store the signals obtained in a 3D memory and then optionally construct split images through the respective object from the stored data according to any cutting plane, as is described in AT 358 155 B, for example. By selecting certain reflexion regions using corresponding evaluation logistics three-dimensional images of the examined object or from regions of the examined object can be called up and displayed, with the added possibility of rotating the object in view or otherwise altering its orientation using other logistics. The data block recorded in the 3D memory is defined three-dimensionally here by the relative position of the successive B images being fed trough different regions of the object, with each B image capturing another region of the object.

### SUMMARY OF THE INVENTION

The aim of the present invention is to propose a new method by means of which movement and, in diagnosis in particular, changes in movement of animated objects can be captured and viewed clearly and comprehensibly.

The task in question is solved by the method explained at the outset in that the split image unit is adjusted to one cutting plane only, wherein the signals obtained from successive split image scannings are converted into a virtual three-dimensional data block, in which the third dimension results from a preset or selectable time interval between successively recorded split images, and from the stored data block data are called up by way of one or more console inquiry stations according to adjustable criteria, namely interfaces or cutting axes by way of this data block or according to signal criteria, and images are displayed on at least one display unit in the form of split images, motion curves, and height-adjusted or depth-adjusted or axonometrically displayed groups of curves giving a spatial impression, or as a three-dimensional impression.

As with the M mode process the sound head, which emits the scanned sound waves and receives the reflecting echo signals, does not change relative to the object. With use of a so-called B image mechanism or also a multi-element sound head not only is an ultrasound line received, but also a complete split image corresponding to a B image. But the data block is obtained from the split images obtained successively from the same object area, wherein the third dimension is determined not, as with the known 3D scanning by the adjustment of the sound head transversely to the scanning plane, but by the interval between two B images originating from the same area. Each individual split image represents the object at another time. Split image views can be derived form the data block according to any selected cutting planes, though this is not evident from the B image itself. Reference is made here inter alia to the possibilities itemised in the abovementioned AT 358 155 B, whereby it should always be kept in maid that the third dimension of storing is a time coordinate converted into a spatial coordinate. The displacement of a dot of the examined object in the recording interval can also be viewed and results in a curved image corresponding to M mode; for example, during heart examinations a UCG shunt through the corresponding area of the heart. If a surface line, for instance the surface contour of a heart valve, is selected from the individual B images and its movement is represented in successive groups of curves, the result is a three-dimensional image in which deviations of movement can easily be captured by the observer by dips or peaks in the spatial formation, whereby the observer will then examine each split image in which deviation occurs.

With further development of the process according to the present invention additional measures which are partly known can be placed into the ultrasound technique in order to improve or facilitate images. For instance, the clarity of the image is improved if undesired signals emanating from area of the object currently not of interest or other signals disturbing the image are excluded either manually or automatically from storage or from viewing. Storage volumes, storage times and access times can be economised in the process.

A method particularly suitable for practical use by doctors is characterised in that at least one split image reconstructed according to a selectable interface by the data block and one image giving a three-dimensional impression are viewed on the display unit at the same time as one of the recorded split images and the actual position of the images relative to one another is indicated by markings. Here, in the normal B image as shown the position of the virtual cutting planes or scanning beams for a UCG image and the like is given by markings, whereby the doctor also has the option of calling up the normal B image for exactly when an irregularity occurred.

According to a further possibility it is provided that for the purposes of displaying the image giving the three-dimensional impression signals of selectable surfaces or reflection surfaces of the object, signals of selectable intensity, for example the strongest and/or weakest signals stored in the data block, are displayed as a transparent object and/or images are made up of mixtures of these criteria. The image giving the three-dimensional impression can be viewed as a niche image.

### BRIEF DESCRIPTION OF THE DRAWING

Further details and advantages of the inventive object are evident from the subsequent description of the drawings. The inventive object is illustrated in the drawings, in which:

FIG. 1 is a simplified block diagram of an examination device utilised in carrying the method according to the present invention into effect,

FIG. 2 shows an image made up of groups of curves in the form of a three-dimensional picture of the movements of a heart valve over a series of heart cycles, for the sake of a more detailed explanation of a possible viewing method, whereby a through line illustrates the heart valve movements over a certain time and the next somewhat parallel lines illustrate the movements in subsequent periods, and

FIG. 3 diagrammatically shows a possible image of the result of an ultrasound examination on the screen according to the method according to the present invention.

### DESCRIPTION OF THE PREFERRED EMBODIMENTS

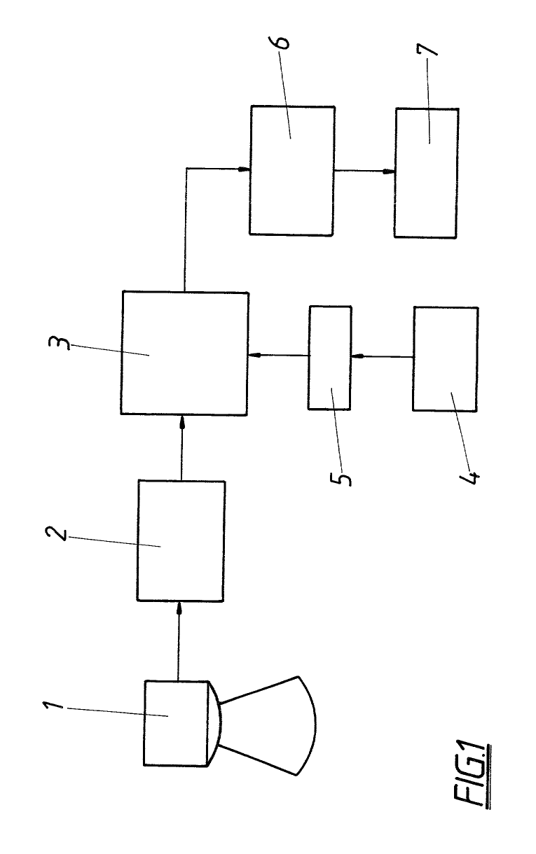

In accordance with FIG. 1 a scanning unit 1 suitable for creating a Bi image is connected to a sender/receiver. Attached to this sender/receiver 2 is a 3D memory in which the individually time-sequenced B images or the signals serving to construct them or signals selected from these B images of the temporal series can be stored addressably. To access the memory for later viewing a addressing unit 4 is provided which can calculate any spatial coordinates, such as cutting planes or interfaces through the stored virtual 3D volume, lines of intersection and the like, or is adjusted to corresponding calculations via a programming unit. A segmenting unit 5 allows disturbing echo signals to be removed for visualising, otherwise manual adjustments of segmenting unit 5 are possible. The data read out of memory 3 by 4, 5 are fed to a data-processing unit 6 which evaluates the addressed signals and forwards them to a display unit 7 for viewing. Addressing unit 4 must be capable of converting the time constants or velocity constants into spatial coordinates by recording a displacement rate of the B image remaining stationary but recording different movement phases of the object. Based on the recording situation it is possible that echo structures or their signals, which could disturb visualisation of the movement of parts of the object of interest, are stored in the data block. For example, should the movement of a heart valve be represented as a surface, then heart structures in the visualisation direction in front of the heart valve influence the image of the valve itself. Such undesired echo structures are excluded from the visualisation process by segmenting unit 5. In the case of manual methods the user marks the areas to be excluded. But there are automatic methods possible which mark the surface of the desired object or object area and thus exclude the echo structures from visualisation.

From a series of echoes along a scanning beam data-processing unit 6 calculates a picture element, which should relay a three-dimensional impression of an object to the observer.

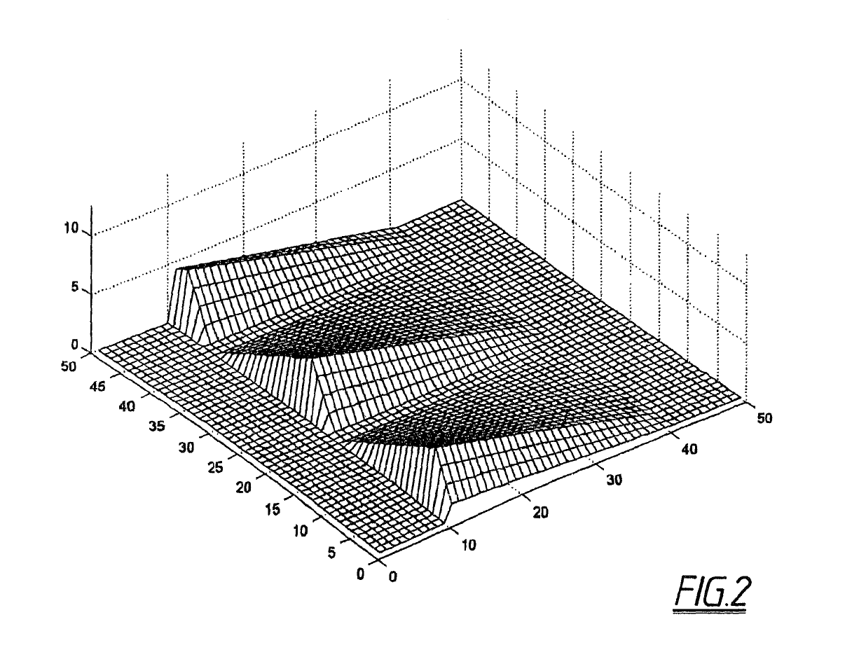

In this respect and in a simplified manner FIG. 2 shows the movement of a heart valve which opens quickly from the rest position, closes more slowly and remains in the rest position until the next heart cycle commences, whereby the curves from the individual B images fill out to the displayed formation during the storage interval and changes in shape permit returns to error functions or are given reason to continue examining.

In the preferred embodiment of the method according to the present invention algorithms are used in the data-processing unit, which either detect a surface or have the effect of displaying the data block as a transparent object. The strongest or weakest echoes along a scanning beam can also be displayed.

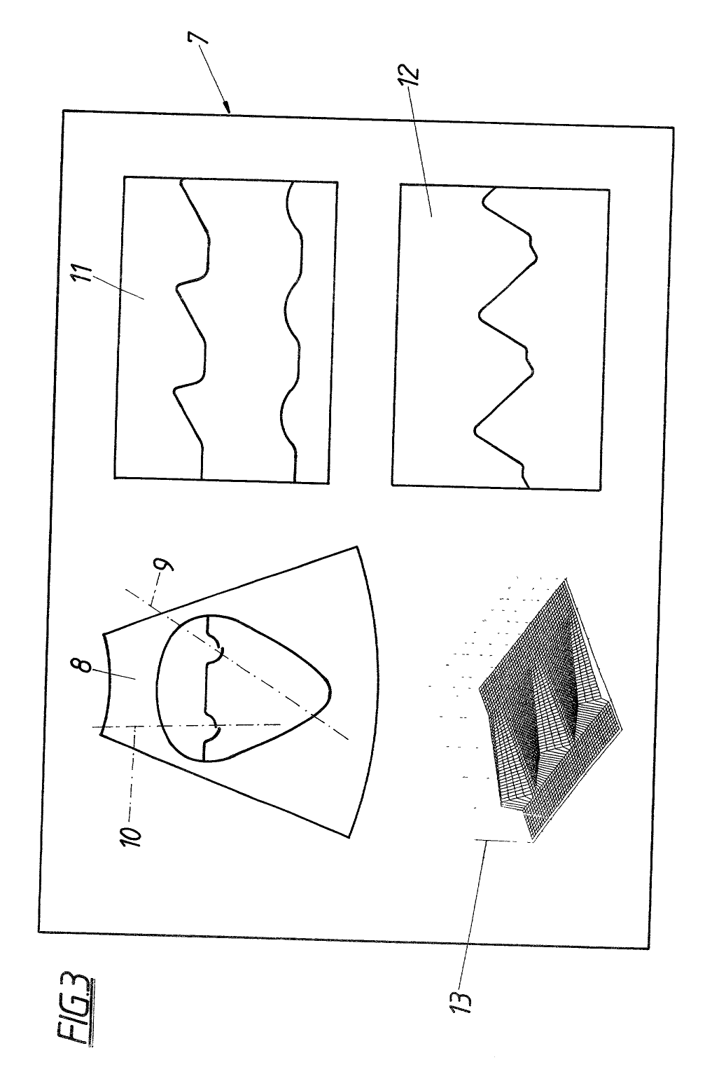

In the preferred form display unit 7 is a monitor, as in FIG. 3. Here, the images obtained as per the method according to the present invention and according to different derivatives, though also other images from ultrasound examination, can be displayed in various display formats. In the present embodiment the monitor is subdivided into four quadrants. The first quadrant displays a B image obtained by 1 from scanning. Markings 9, 10, which represent the position of a sound beam during M image scanning, can be faded into this B image. Two curve paths corresponding to practically one UCG of one heart valve and the rear heart wall are derived from marking 9 in field 11. The view after field 2 corresponds to a derivation after marking 10 and, finally, another three-dimensional image is faded in last field 13, as shown in FIG. 2.

1. A method for representing movements when examining animated objects with ultrasound, wherein the object is scanned with an ultrasound split-field unit and the split images are stored in a memory unit, characterised in that
the split image unit is adjusted to one cutting plane only,
the signals obtained from successive split image scannings are converted into a virtual three-dimensional data block, in which the third dimension results from a preset or selectable time interval between successively recorded split images, and
from the stored data block data are called up by way of one or more console inquiry stations according to adjustable criteria, namely interfaces or cutting axes by way of this data block or according to signal criteria, and images are displayed on at least one display unit in the form of split images, motion curves, and height-adjusted or depth-adjusted or axonometrically displayed groups of curves giving a spatial impression, or as a three-dimensional impression.

2. Method as claimed in claim 1, characterised in that undesired signals emanating from area of the object currently not of interest or other signals disturbing the image are excluded either manually or automatically from storage or from viewing.

3. Method as claimed in claim 1 or 2, characterised in that at least one split image reconstructed according to a selectable interface by the data block and one image giving a three-dimensional impression are viewed on the display unit at the same time as one of the recorded split images and the actual position of the images relative to one another is indicated by markings.

4. Method as claimed in claims 1 to 3, characterised in that for the purposes of displaying the image giving the three-dimensional impression signals of selectable surfaces or reflection surfaces of the object, signals of selectable intensity, for example the strongest and/or weakest signals stored in the data block, are displayed as a transparent object and/or images are made up of mixtures of these criteria.

5. Method as claimed in any one of claims 1 to 4, characterised in that the image giving the three-dimensional impression is viewed as a niche image.
